(19) United States
(12) Patent Application Publication
(10) Pub. No.: US 2022/0372810 A1
(43) Pub. Date: Nov. 24, 2022

(54) SWITCH SAFETY DEVICE

(71) Applicant: Warren Christopher Nelson, II, Boyne City, MI (US)

(72) Inventor: Warren Christopher Nelson, II, Boyne City, MI (US)

(21) Appl. No.: 17/452,608

(22) Filed: Oct. 28, 2021

Related U.S. Application Data
(60) Provisional application No. 63/202,019, filed on May 24, 2021.

(51) Int. Cl. E05F 15/44; B60J 11/06

(52) U.S. Cl. CPC E05F 15/443; B60J 11/06; E05Y 2800/426; E05Y 2900/55

(57) ABSTRACT

A vehicle safety device that prevents the activation of automatic or power switches in a vehicle. The vehicle safety device may have a protrusion that engages or obstructs the switch by filling the void adjacent the switch, the finger groove, thereby preventing access to the finger groove and/or not allowing the switch to be moved into an activation position. The protrusion may have a tab the further prevents the switch from moving from an inactivated state to an activated state. The protrusion is connected to an underside of a hard shell covering the entire switch area/panel, thereby preventing access to a plurality of switches and thus also preventing their inadvertent activation.

### CROSS-REFERENCE TO RELATED APPLICATION

This application claims the benefit of priority of U.S. provisional application No. 63/202,019, filed 24 May 2021, the contents of which are herein incorporated by reference.

### BACKGROUND OF THE INVENTION

The present invention relates to switch safety locks and, more particularly, a device adapted to prevent the inadvertent activation of automatic switches, including the opening of a vehicle's window by a careless individual, a small child, and/or a pet. The present invention reduces the possibility of loss or injury to passengers, and thereby affording the driver peace of mind and an undistracted attention on the road.

When traveling with pets, many people allow their pets to stick their heads out of the windows of their vehicle, typically with the window partially open. Additionally, people often leave their pets in the car unattended also with the window partially open. In vehicles with windows partially open, children and pets risk injury to their heads or hands/paws, should automatic windows close through unintended activation. In vehicles with wide open windows, pets and small children risk being jettisoned out of the window.

Current solutions in this field cover too much area and look bad; for instance, asking a user to attach a bulky, aesthetically unpleasing retaining net to their vehicle so that it covers substantially all of the window. People tend to prize the aesthetics of their vehicle, and so the more unappealing the less likely it is to be used, doing no one any good.

As can be seen, there is a need for a vehicle safety device adapted to keep individuals and animals from inadvertently activating a vehicle's window. The vehicle safety device embodied in the present invention solves the problem by blocking the switch from being engaged while also being easily removed by an adult to return the window control buttons to their normal state. The present invention is also small, quickly installed and removed, flexible, and looks attractive or at least discreet.

### SUMMARY OF THE INVENTION

In one aspect of the present invention, a switch safety device having the following: a body have a lower surface; the lower surface having a recess defined by a periphery; a protrusion extending from the periphery to over the recess; and a tab extending from a distal end of the protrusion, wherein the protrusion is bulbous and wherein the tab tapers extending away from the protrusion, wherein the protrusion and wherein the tab have a hard hat shape.

In another aspect of the present invention, a switch safety system, the system includes a switch with a finger cavity adjacent to the switch with a projection and a switch safety device including the following: a body having a lower surface; the lower surface having a recess defined by a periphery; a protrusion extending from the periphery to over the recess; and a tab extending from a distal end of the protrusion, wherein the protrusion substantially fills the finger cavity and the tab extends to adjacent to the projection, wherein the recess circumscribes the switch.

In another aspect of the present invention, a method of providing a safety lock for a switch, the switch having finger cavity adjacent to the switch, the method including occupying the finger cavity with a protrusion of a body, wherein the body covers the finger cavity and the switch.

These and other features, aspects and advantages of the present invention will become better understood with reference to the following drawings, description and claims.

### BRIEF DESCRIPTION OF THE DRAWINGS

FIG. 1 is a top perspective view of an exemplary embodiment of the present invention. FIG. 2 is a bottom perspective view of an exemplary embodiment of the present invention.

FIG. 3 is a side elevation of an exemplary embodiment of the present invention.

FIG. 4 is an exploded clamshell perspective of an exemplary embodiment of the present invention shown in use.

FIG. 5 is a top perspective view of an exemplary embodiment of the present invention shown in use.

FIG. 6 is a cross-sectional view of an exemplary embodiment of the present invention shown in use, taken along line 6-6 in FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a vehicle safety device that prevents the activation of automatic or “power” switches in vehicles. The vehicle safety device may have a protrusion that engages or obstructs the switch by filling the void adjacent the switch, the “finger groove”, thereby preventing access to the finger groove and/or not allowing the switch to be moved into an activation position. The protrusion may have a tab the further prevents the switch from moving from an inactivated state to an activated state. The protrusion is connected to an underside of a hard shell covering the entire switch area/panel, thereby preventing access to a plurality of switches and thus also preventing their inadvertent activation.

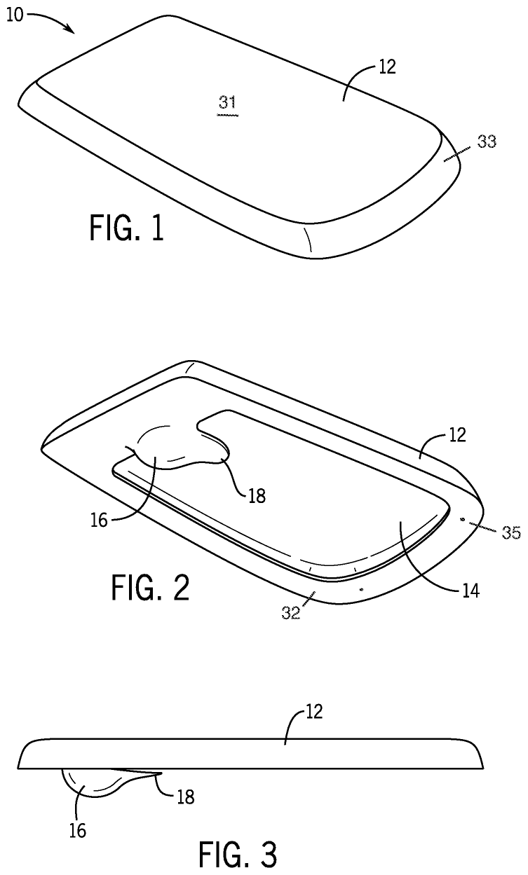

Referring now to FIGS. 1 through 6, the present invention may include a vehicle safety device 10 made of rubber, silicone, plasticized materials, polymeric material, and/or other natural or synthetic materials that enable the functionality disclosed herein.

The device 10 has body 12 having a first surface 31 and an opposing second surface 32. The first and second surfaces 31 and 32 may be interconnected by a sidewall 33. The second surface 32 may provide a recess 14 therein. In use, the recess 14 is dimensioned and adapted to cover the switch 22 and/or switch panel 26, thereby accommodating differently sized and shaped switches 22. On the second surface 32, along a periphery defined by the recess 14, a protrusion 16 may extend over the recess 14. Conceptually, the recess 14 would be the swimming pool and the protrusion 16 the diving board. Extending from a distal end of the protrusion 16 is a planar or tapered tab 18. In some embodiments, the protrusion 16 may be approximately ¾ of an inch in width, approximately ¾ of an inch in length, and about ¼ of inch deep. In some embodiments, the tab 18 may extend about ⅛ of an inch along a longitudinal axis which also defines the length of the protrusion 16. The protrusion 16 may be generally bulbous, approximately semi-spherical. The tab 18 may taper downward in thickness as the tab 18 extends away from the protrusion 16. Together, the protrusion 16 and the tab 18 may have a smooth hard hat shape. In certain embodiments, there may be more than one protrusion 16 if there is a switching panel 26 with a plurality of switches 22 and 24 in need of obstructing.

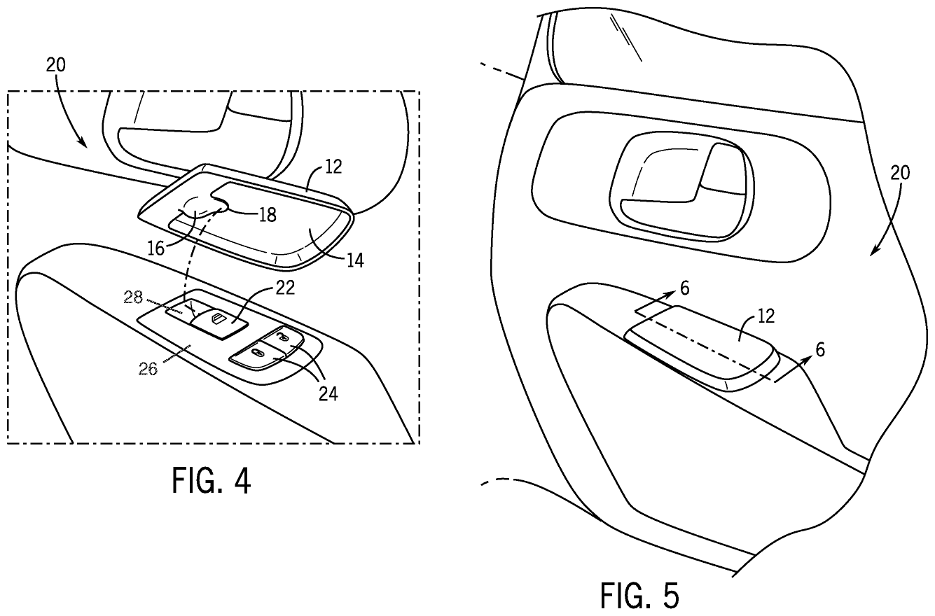

The second surface 32 may be dimensioned and adapted to grip the switch panel 26 that surrounds the switches 22 and the locks 24, as illustrated in FIG. 4 through 6. Because of the material (say, rubber), because of the texture/gripping 35, or a combination thereof, the second surface 32 grips the panel 26 or other surrounding area of the switches 22 and/or locks 24. In such an “attached condition”, as illustrated in FIG. 5, the first surface 31 acts as a dome, preventing inadvertent access to the switches 22/locks of the switch panel 26.

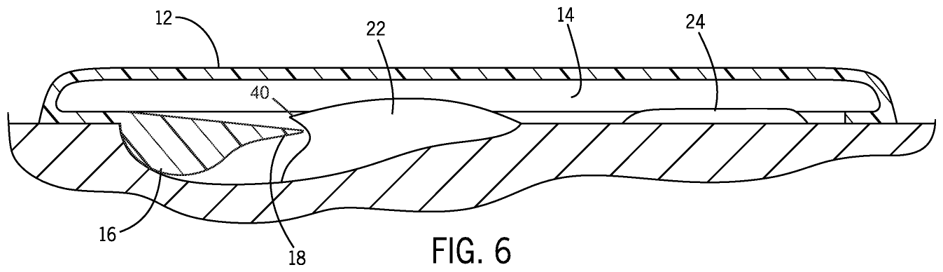

While in the attached condition the protrusion 16 substantially fills the finger groove/cavity 28 adjacent to switch 22 where, if unobstructed, a user of the switch 22 would occupy with a tip of their finger to activate the switch 22, typically by urging a projection 40 thereof. Typically, the finger cavity 28 has a curved surface as it moves from the switch panel 28 to the switch 22, wherein the curved, bulbous shape of the protrusion 16 conforms to when the device 10 is in the attached condition, as illustrated in FIG. 6. In this nested position, the tab 18 extends to just under or above the projection 40 of the switch 22, thereby further obstructing the switch's movement from an inactivated state to an activated state.

A method of manufacturing the present invention may include the following. A manufacturer may cast of the door arm rest 20 then make a mold out of the cast. After that, the manufacture may pour the liquid rubber/silicone or the like into the mold along with having the plastic dome in position. The first surface 31 needs to provide sufficient hardness/stiffness, using the durometer scale, in certain embodiments. The second surface 32 needs to use material that provides at least both flexibility and traction.

A method of using the present invention may include the following. The vehicle safety device 10 disclosed above may be provided. A user would put the protrusion 16 of the vehicle safety device 10 into the finger cavity 28 adjacent the switch 22 so it obstructs engagement of the switch 22, specifically moving the projection 40 to the activated state. The first surface 31 acts as a dome or cover of the switch 32 and surrounding area/switch panel 26. When the device 10 is in the attached condition, with the protrusion 16 in the nested position, the driver can operate the vehicle with peace of mind. To remove the vehicle window safety device 10, the user would just grab and lift it up and out of the finger cavity 28. Thereby, the present invention would prevent animals and young kids from unrolling windows, which could lead to embarrassment, accidents or the animal/kid getting out of vehicle.

It should be understood that the device 10 could be used to prevent use of the lock switch 24 as well. Additionally, the present invention could be used in a factory or anywhere a switch-operated device was in use, wherein the inadvertent activation of said switch-operated device would be dangerous to those nearby.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Alternatively, as used in this application, the term “about” or “approximately” refers to a range of values within plus or minus 10% of the specified number. And the term “substantially” refers to up to 90% or more of an entirety. Ranges of values and/or numeric values are provided herein as examples only, and do not constitute a limitation on the scope of the described embodiments. The use of any and all examples, or exemplary language (“e.g.,” “such as,” or “the like”) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A switch safety device, comprising:
a body have a lower surface;
the lower surface having a recess defined by a periphery;
a protrusion extending from the periphery to over the recess; and
a tab extending from a distal end of the protrusion.

2. The switch safety device of claim 1, wherein the protrusion is bulbous and wherein the tab tapers extending away from the protrusion.

3. The switch safety device of claim 1, wherein the protrusion and wherein the tab have a hard hat shape.

4. A switch safety system, the system comprising:
a switch with a finger cavity adjacent to the switch with a projection; and
switch safety device, comprising:
a body having a lower surface;
the lower surface having a recess defined by a periphery;
a protrusion extending from the periphery to over the recess; and
a tab extending from a distal end of the protrusion,
wherein the protrusion substantially fills the finger cavity and the tab extends to adjacent to the projection.

5. The system of claim 4, wherein the recess circumscribes the switch.

6. A method of providing a safety lock for a switch, the switch having finger cavity adjacent to the switch, the method comprising occupying the finger cavity with a protrusion of a body, wherein the body covers the finger cavity and the switch.
